(19) United States
(12) Patent Application Publication
(10) Pub. No.: US 2012/0132676 A1
(43) Pub. Date: May 31, 2012

(54) LIQUID DISPENSER

(76) Inventor: Reginal Rhodes, Orangeburg, SC (US)

(21) Appl. No.: 12/955,985

(22) Filed: Nov. 30, 2010

(51) Int. Cl. B67D 7/58; B67D 7/78

(52) U.S. Cl. 222/377; 222/464.7

(57) ABSTRACT

A liquid dispenser for dispensing liquid comprising: a bottle, where said bottle includes an opening and a base, where said base includes a concaved shape on the interior of the bottle; a pump, where said pump is secured within the opening; and a tubing extending downwardly into the bottle from the pump. The liquid dispenser may include a hand depressing pump or alternatively a spray type pump. For optimum dispensing, the tubing extends into the center of the concaved base.

### BACKGROUND OF THE INVENTION

1. Field of Invention

The present invention relates to an improved liquid dispenser that includes properties to increase the efficient consumption of contents within the dispenser.

2. Description of Related Art

Liquid dispensers for cosmetic and cleaning liquids typically are small plastic bottles that include a means for the dispensing of the liquid within dispenser. Many of these liquid dispensers are used for soaps, lotions and creams. A number of the bottles use gravity or a user applies pressure by squeezing the bottle for the liquid to disperse from a small opening usually in the top of the bottle. Some of these liquid dispensers may include a spray pump or a hand pump that suctions the liquid through a straw-type tubing and then emits the liquid into the user's hand or onto surface being cleaned with regard to any soap or cleaning liquid.

The typical dispensers may vary in size but usually contains a few ounces up to 20 or 30 ounces of fluid within the container for use. The common hand pump utilizes a straw-like tubing that extends downwardly into the dispenser, many times the bottom surface of the dispenser is flat and therefore the pump-type dispenser may leave unused liquid within the container. Most of the unused residue is unable to be suctioned through to the tubing due to the positioning of the tube that extends into the dispenser. Many times the tube is extended downward in the center of the dispenser and functions in an efficient manner until a low level liquid is left within the dispenser. It would therefore be advantageous to have a bottle of that is suitable to encourage movement of liquid thru the tubing within a hand pump type of liquid dispenser. Such a type of a dispenser could incorporate both gravity and the use of the hand pump system to retrieve liquid within the dispenser.

### SUMMARY OF THE INVENTION

The present invention relates to a liquid dispenser for dispensing liquid comprising: a bottle, where said bottle includes an opening and a base, where said base includes a concaved shape on the interior of the bottle; a pump, where said pump is secured within the opening; and a tubing extending downwardly into the bottle from the pump. The liquid dispenser may include a hand depressing pump or alternatively a spray type pump. For optimum dispensing, the tubing extends into the center of the concaved base.

### BRIEF DESCRIPTION OF DRAWINGS

FIG. 1 depicts a prospective view of a liquid dispenser bottle according to the present invention.

### DETAILED DESCRIPTION

The present invention relates to a liquid dispenser that improves the performance of a hand pump style liquid dispenser. The liquid dispenser according to the present invention utilizes a unique base within the interior of the bottle to ensure adequate access to the liquid contents through the use of a hand pump system. The present invention includes a concaved foundation that uses gravity to position the liquid in the optimal position for access by a hand pump type of a liquid dispenser. The concave foundation encourages the movement of a liquid to the tubing that extends into the liquid dispenser and therefore provides a more effective access to the liquids within the dispenser.

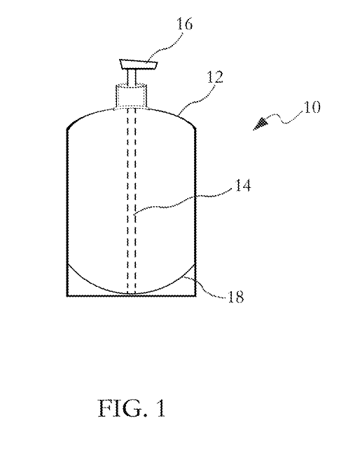

FIG. 1 depicts a prospective view of the liquid dispenser according to the present invention. Liquid dispenser 10 includes a base portion 18, a bottle 12 and a hand pump 16. The hand pump 16 includes tubing 14 that extends downwardly to the base 18. The hand pump 16 functions in a normal manner where the pump 16 is depressed to suction liquid through the tubing 14. An opening is provided at the top of the pump 16 for the disbursement of liquid contained within the bottle 12. As depicted, the base 18 has a concave shape that allows the placement of tubing 14 at the center thereof. The concave base 18 therefore encourages the movement of liquid toward the tubing 14 so that the liquid is readily accessed when the hand pump 16 is depressed.

The concave shape of the base 18 encourages the movement of the liquid to allow the easy discharge of liquid through the hand pump 16. The shape of the base 18 helps to avoid the shaking, turning and other movement of the liquid dispenser once the contents of the dispenser at a low level. Also the base 18 helps to decrease unused residue of any liquid lotion in the bottle 12. The view provided in FIG. 1 is a view of the internal compartment of the bottle 12.

What is claimed is:

1. A liquid dispenser for dispensing liquid comprising:
a. a bottle, where said bottle includes an opening and a base, where said base includes a concaved shape on the interior of the bottle;
b. a pump, where said pump is secured within the opening; and
c. a tubing extending downwardly into the bottle from the pump.

2. The liquid dispenser according to claim 1, where pump is hand depressing pump.

3. The liquid dispenser according to claim 1, where the pump is a spray type pump.

4. The liquid dispenser according to claim 1, where the tubing extends into the center of the concaved base.
